(19) United States
(12) Patent Application Publication
(10) Pub. No.: US 2022/0368812 A1
(43) Pub. Date: Nov. 17, 2022

(54) GENERATING PRINT AGENT ELEMENT SETS

(71) Applicant: HEWLETT-PACKARD DEVELOPMENT COMPANY, L.P., Spring, TX (US)

(72) Inventors: Peter MOROVIC, Sant Cugat del Valles (ES); Jan MOROVIC, London (GB); Alessandro BELTRAMI, Sant Cugat del Valles (ES); Sergio ETCHEBEHERE JUAN, Sant Cugat del Valles (ES); Xavier FARINA VARGAS, Sant Cugat del Valles (ES); Hector GOMEZ MINANO, Sant Cugat del Valles (ES); Joan VIDAL FORTIA, Sant Cugat del Valles (ES)

(21) Appl. No.: 17/771,396

(22) PCT Filed: Nov. 18, 2019
(86) PCT No.: PCT/US2019/061945

§ 371 Date: Apr. 22, 2022

(51) Int. Cl. H04N 1/60; H04N 1/52; B33Y 50/00; B29C 64/386

(52) U.S. Cl. CPC H04N 1/6097; H04N 1/6022; H04N 1/52; B33Y 50/00; B29C 64/386

(57) ABSTRACT

A method is disclosed. According to some examples, the method comprises determining, by processing circuitry, a first element set to be associated with a print addressable location, the first element set comprising a first plurality of elements, wherein each element of the first plurality of elements identifies a print colorant or print colorant combination and is associated with a probability that the print colorant or print colorant combination identified by that element is to be applied to the associated print addressable location. The method may comprise determining, by processing circuitry, a second element set to be associated with the print addressable location, the second element set comprising a second plurality of elements, wherein each element of the second plurality of elements identifies a print agent or print agent combination and is associated with a probability that the print agent or print agent combination identified by that element is to be applied to the associated print addressable location. The method may comprise determining, by processing circuitry, a combined element set based on the first element set and the second element set. An apparatus and a machine-readable medium are also disclosed.

### BACKGROUND

Print apparatuses may generate printed articles (e.g. images in two-dimensional printing, or three-dimensional articles in three-dimensional printing) during a printing operation. Input data representing an article to be printed is converted into print instructions used during the printing operation.

In some printing operations, it may be intended that different types of printing fluid are to be used to print a single article, and in such printing operations, a first type of printing fluid may be printed on top of and/or alongside a second type of printing fluid.

### BRIEF DESCRIPTION OF DRAWINGS

Examples will now be described, by way of non-limiting example, with reference to the accompanying drawings, in which:

FIG. 1 is a flowchart of an example of a method of determining an element set;

FIG. 2 is flowchart of a further example of a method of determining an element set;

FIG. 3 is an illustration of examples of half-tone matrices;

FIG. 4 is a schematic illustration of an example of apparatus for determining an element set;

FIG. 5 is a schematic illustration of an example of a print apparatus; and

FIG. 6 is a schematic illustration of an example of a processor in communication with a machine-readable medium.

### DETAILED DESCRIPTION

In the case of two-dimensional printing, an image to be printed may be processed using one of a number of a half-toning techniques, which involves converting a continuous tone, or con-tone, image into a half-tone representation of the image which the printing system can use to print the image. A half-tone representation, or a half-tone image, may be considered to be a matrix of pixels, each of which being capable of being printed by the printing system. Thus, each pixel may be referred to as a print addressable location. Each cell of the half-tone matrix may include an indication of the nature of, and amount of, a print agent to be delivered to a corresponding print addressable location during a printing operation to form the image.

Continuing with the two-dimensional printing example, a print addressable location may be represented by at least one pixel, and each print addressable location may be printed with at least one colorant such as inks (for example cyan, magenta, yellow and black inks), coatings or other print materials, as well as combinations of those print materials. In some examples, it may be intended that a colorant or a combination of colorants is to be delivered to a print addressable location in addition to another printing agent, such as a fixer, a binder, an overcoat or coating, a pre-treatment, a gloss enhancer, a spot gloss, and the like). The additional or extra printing agent may be considered to comprise a printing agent that is not a colorant. The additional printing agent may, for example, complement a colorant that has been delivered to the print addressable location, for example, to enhance the color or to prevent or reduce the likelihood of print defect occurring with regard to the colorant. In some examples, it may be intended that the additional printing agent is to be delivered to a print addressable location that is adjacent to a print addressable location on which a colorant has been delivered, such that the additional printing agent is to be delivered to a print addressable location on which no colorant has been delivered.

In the case of three-dimensional printing, which is also referred to as additive manufacturing, three-dimensional space may be characterized in object model data in terms of ‘voxels’, i.e. three-dimensional pixels, wherein each voxel occupies or represents a discrete volume. In examples of three-dimensional printing therefore, an addressable area may correspond to at least one voxel and each voxel may be ‘printed’, i.e. generated or manufactured, using one or a combination of printing agents and/or build materials. As with two-dimensional printing, it may be intended to deliver different types of printing agents (e.g. a colorant and a coalescing agent) to the same voxel, or to adjacent voxels.

To briefly discuss three-dimensional printing in greater detail. objects generated by an additive manufacturing process may be formed in a layer-by-layer manner. In one example, an object is generated by solidifying portions of layers of build material. In examples, the build material may be in the form of a powder or powder-like material, or may be a fluid or a sheet material. In some examples, the intended solidification and/or physical properties may be achieved by printing an agent onto a layer of the build material. Energy may be applied to the layer and the build material on which an agent has been applied may coalesce and solidify upon cooling. In other examples, directed energy may be used to selectively cause coalescence of build material, or chemical binding agents may be used to solidify a build material. In other examples, three-dimensional objects may be generated by using extruded plastics or sprayed materials as build materials, which solidify to form an object, and may be colored in a post processing step.

When multiple types of print materials are to be used in a printing process (e.g. a colorant and an extra fluid), the quality of the final printed article (e.g. an image or an object) may be affected by the precise locations at which the various print materials are delivered. In an example, it may be intended that an overcoat fluid is to be delivered in locations where over a colorant has been delivered, and not in locations where no colorant has been delivered. Delivering the overcoat fluid to locations where colorant has not been delivered (e.g. onto blank regions of a printable substrate in two-dimensional printing) may result in overcoat fluid being wasted and may, in some examples, result in the printable substrate suffering a detrimental effect. In another example, it may be intended that a treatment fluid is to be delivered to locations on a printable substrate where no colorant has been delivered. Delivering the treatment fluid to locations where colorant has been delivered may have a detrimental effect on the colorant. Having the ability to determine and control accurately where different print materials are to be delivered during a printing operation may help to avoid some of the above-mentioned print quality defects from occurring. Examples described herein may help to avoid some of the above-mentioned print quality defects.

In examples herein, possible print materials to be applied to an addressable location (e.g. to provide a particular color) are specified within an element set, which may be referred to as a vector. In some examples, the print materials may be identified explicitly, i.e. in a set of elements comprising a set of print materials and/or print material combinations. In other examples, it may be that at least one of the elements of an element set relates to another quality, which may in turn be related to print materials. For example, an element may specify a property or the like which can be mapped to print materials. In another example, the elements may be specified in terms of Neugebauer Primaries (a set of the print materials and print material combinations (and in some examples, an amount of print material, such as the number of drops of printing agent) which can be applied by a particular print apparatus).

In some examples, a set of elements is expressed as a print material coverage representation which defines print material data, for example detailing (explicitly or implicitly, for example via a mapping) the amount of print materials (such as a colorant or coating for two dimensional printing or an agent(s) to be deposited onto a layer of build material, or in some examples, build materials themselves for three dimensional printing), and, if applicable, their combinations.

For example, a print addressable location within input data (for example, a pixel in image data or a voxel in object model data) may be associated with an element set. The element set(s) may include elements which specify (directly or via a mapping) print materials and print material combinations which may be applied to the location, each element being associated with a probability of being applied to that location. In the case of two-dimensional printing, these may be referred to as area coverage vectors and/or, when the set of elements comprise the Neugebauer Primaries (NPs), as Neugebauer Primary Area Coverage vectors (NPac vectors, or simply NPacs herein), which are the possible print material amounts and combinations which may be applied to a single print addressable location. The possible NPs are all the possible states for a single pixel/voxel for a printing system having a set of print agents. For example, for a binary (bi-level) printer, an NP is one of 2^{k} combinations of k print agents within the printing system, wherein print agents can be represented in single-drop states, in a k-dimensional color space. More generally, there may be Aⁿ combinations for a set of n print agents having A drop states, which may define all of the possible print agent configuration states that a single pixel can receive, and therefore there may be Aⁿ NPs.

In the case of three-dimensional printing, these may be referred to as volume coverage vectors, Material Volume coverage vectors (also termed Mvoc vectors, or simply MVocs, herein), which may also specify combinations of print agents.

As noted above, such element sets provide a probability that a print material or a combination of print materials may be applied in a location. In a simple case, an element set may indicate that the particular print material or print material combination should be applied to that location on X % of occasions, whereas on (100−X)% of occasions the location should be left clear of the print material. In practise, this may be resolved at the addressable resolution for the print material and/or printing device. Therefore, if there are N addressable locations in an XY plane associated with such an element set, around X % of these N locations may be expected to receive a print material, while around (100−X) % do not. This region of the XY plane may be intended to be perceived as a color associated with the element set.

For example, in a printing system with two available print materials (for example, inks, coatings or agents), identified as M1 and M2, where each print material may be independently deposited in an addressable area (e.g. voxel or pixel) as single drop, there may be 2² (i.e. four) probabilities in a given Mvoc or NPac coverage vector: a first probability for M1 without M2; a second probability for M2 without M1; a third probability for an over-deposit (i.e. a combination) of M1 and M2, e.g. M2 deposited over M1 or vice versa; and a fourth probability for an absence of both M1 and M2 (indicated as Z herein). In this example, it is assumed that a drop of print material may be applied or not; i.e. a binary choice may be made and the value for each agent may be either 0 or 1. The full set of NPs of the example printing system are therefore M1, M2, M1M2 and Z.

In this case, a vector or element set may be: [M1:P1, M2:P2, M1M2P3, Z:P4] or with example probabilities [M1:0.2, M2:0.2, M1M2:0.5, Z:0.1]—in a set of print addressable locations (e.g. an [x, y] or an [x, y, z] location (which in some examples may be an [x, y] location in a z slice)) to which the element set applies, and on average, 20% of locations are to receive M1 without M2, 20% are to receive M2 without M1, 50% are to receive M1 and M2 and 10% are to be left clear (Z).

In non-binary systems, there may be more elements defined describing the different amounts of print agent and/or associated combinations of print agents, which may be applied (i.e. there may be more NPs). As each value is a proportion and the set of values represent the available material combinations, the set of probability values in each element set generally sum to 1 (or 100%). Where the probability associated with an NP is zero, then that NP may be (effectively or actually) absent from the vector/element set.

In summary then, an NPac/MVoc describes area coverages for a plurality of NPs of print agent set, and comprises probabilities for elements including up to all the NPs. This NPac or MVoc type of vector may be compared to another example of a vector in which the area/volume coverage is controlled but the ‘at pixel’ or ‘at voxel’ choices are not (“print agent vectors” herein). For example, such a print agent vector may specify that X % of a region receives agent M1 and Y % receives agent M2, but the overprinting of agents is not explicitly defined (although the sum of X and Y may be greater than 100, so overprinting may result).

As is clear from the above discussion, print agent coverage vectors may be used to define a probability of each colorant to be delivered within a particular region. In addition, print coverage vectors may be used to define a probability of other printing agents, such as the additional printing fluids (e.g. fixer, overcoat, pre-treatment, etc.) discussed above. Thus, for the same region, a first print coverage vector may define the probability of each colorant to be delivered and a second print coverage vector may define the probability of each colorant to be delivered. By determining the probabilities for both types of printing agent at the half-tone level (i.e. using print coverage vectors), a more controlled application of the different types of printing fluids can be achieved, with additional printing fluids deliberately coinciding with (overprinting) a colorant, or deliberately not overprinting (e.g. not being printed over a colorant).

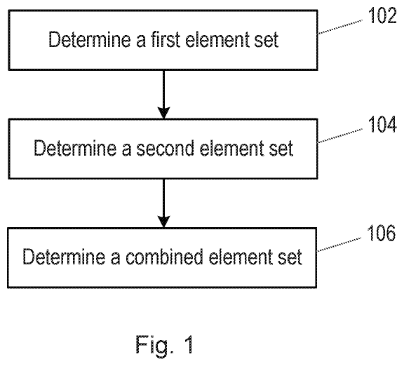

FIG. 1 is an example of a method 100, which may be a computer implemented method of determining or generating an element set, which may be carried out by a processor or multiple processors. The element set may be one of a plurality of element sets, which may for example be intended for inclusion in a color mapping resource. The element set may be intended to provide an area or volume coverage vector such as an NPac or MVoc.

The method 100 comprises, at block 102, determining, by processing circuitry, a first element set to be associated with a print addressable location. The first element set comprises a first plurality of elements, wherein each element of the first plurality of elements identifies a print colorant or print colorant combination. Each element is associated with a probability that the print colorant or print colorant combination identified by that element is to be applied to the associated print addressable location. The print colorant may, in some examples, comprise ink or some other fluid used for the purpose of applying color to an article to be printed. Thus, the elements of the first element set may relate to the probability of particular colorants being applied within a particular region.

At block 104, the method 100 comprises determining, by processing circuitry, a second element set to be associated with the print addressable location, the second element set comprising a second plurality of elements, wherein each element of the second plurality of elements identifies a print agent or print agent combination and is associated with a probability that the print agent or print agent combination identified by that element is to be applied to the associated print addressable location. The print agent may, in some examples, comprise non-colorant print agent and may, for example, comprise a print material intended to supplement the colorant, either by coinciding with (overprinting) or by being delivered beside, next to or away from (e.g. separated from, or not coinciding with) the colorant.

The elements of each element set may comprise NPs. The first element set and the second element set may therefore be determined using techniques discussed above in the discussion of NPacs. Prior to determining the first and second element sets (blocks 102 and 104 respectively), an article (e.g. an image) to be printed may be converted into a form suitable for use by a print apparatus, using a half-toning technique. In some examples, a half-toning technique referred to as Parallel Random Weighted Area Coverage Selection (PARAWACS) half-toning may be used. PARAWACS will be familiar to those active in the field of half-toning. Building on the above discussion, an example of the PARAWACS half-toning technique, is discussed below.

As noted above, an NPac can be considered to represent a probability distribution for the print addressable locations at which colorant/print agent is to be delivered within a region of an article to be generated. Each element in an element set may define a probability that a particular colorant/print agent is to be delivered in the associated print addressable location. One way to achieve more consistency (i.e. to achieve a more uniform spatial distribution) is to generate uniformly distributed random numbers during the half-toning process, using a standard random number generator and scaling them to a range of 0 to 100 (the range of the NPacs). Then, depending on the randomly generated value, a different NP is chosen from the NPac, proportionally to its probability or area coverage. To simplify this selection, the NPac can be expressed cumulatively. For example, imagine for one print addressable location that an NPac is expressed as [Blank 80%, 1 drop magenta (M) 10%, 1 drop cyan (C) 10%] or a shorthand (with W denoting blank substrate, typically white (W)): [W=80%, M=10%, C=10%] becomes in cumulative terms [W=80%, M=90%, C=100%], which in turn defines intervals for each of the NPs such that [0 to 80] corresponds to the Blank state, [80 to 90] to one drop of M and [90 to 100] to one drop of C. Given this representation, the random numbers generated simply need to be categorized according to the intervals. If a random number at print addressable location (e.g. pixel) [x, y] is in the range [0 to 80] it is left blank, if it is in the range [80 to 90] a drop of M is placed and if the random number is in the interval [90 to 100] a C drop is placed.

Thus, determining the first element set (block 102) constitutes determining the probabilities of various colorants or combinations of colorants to be delivered at a print addressable location in an article (e.g. an image or an object) to be formed (e.g. printed), and determining the second element set (block 104) constitutes determining the probabilities of various additional print agents or print agent combinations to be delivered at the print addressable location in the article to be formed.

As noted above, once the article to be printed has been half-toned, a half-tone matrix representation of the article defines, for each print addressable location, a number between 0 and 100. If an element of an element set exceeds the number in a particular print addressable location of the half-tone matrix, then that the particular colorant/print agent element is to be delivered (or not delivered if blank space is intended) in that particular print addressable location. Since this is true for any type of print agent to be delivered, it is possible to achieve consistent outcomes when the different element sets (e.g. the first and second element sets) are applied to the same half-tone matrix.

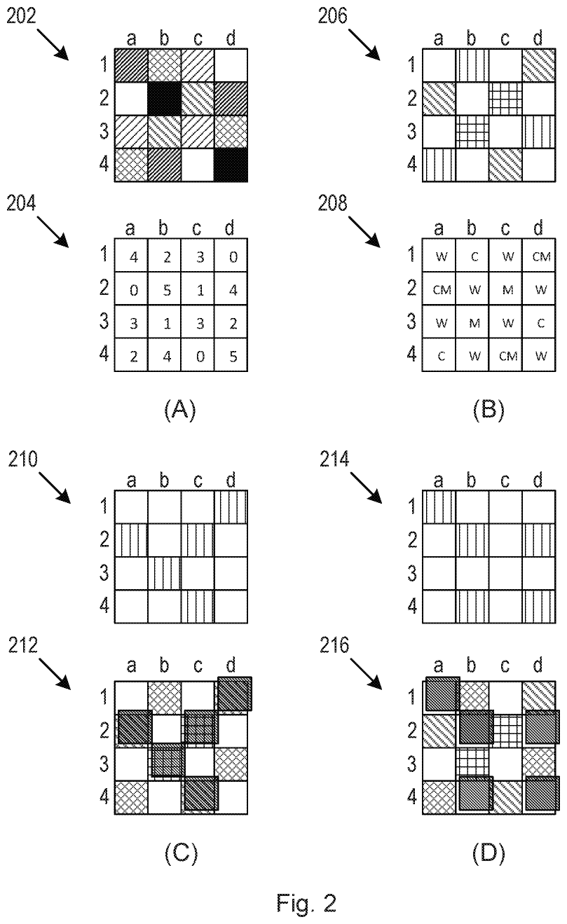

The order in which the elements (e.g. NPs) are defined and/or determined in an element set can affect the outcome of the printed article. The order or the elements determines the order in which the cumulative distribution is built. For example, a first element set (e.g. an NPac) for colorants may include the elements (e.g. NPs) CM (one drop of cyan and one drop of magenta), M, C, and W (white, or blank). The order in which the elements are considered may be CM, M, C, W. If an additional print agent (e.g. a fixer) is to be delivered in addition to the colorant, then a second element set may include the elements F (e.g. fixer) and W (blank). If it is intended that the fixer is to be delivered (as much as possible) in the same print addressable locations as the colorant, then the order of the elements for the additional print agent is F, W. However, if it is intended that the fixer is to be delivered (as much as possible) in the blank regions of the article, where no colorant has been delivered, then the order of the elements for the additional print agent is W, F. While the term “fixer” is used in some examples herein, it is to be understood that this may alternatively be any other type of additional fluid or print fluid. The effect of varying the order of the elements is exemplified below with reference to FIG. 2.

Referring again to FIG. 1, the method 100 comprises, at block 106, determining, by processing circuitry, a combined element set based on the first element set and the second element set. Thus, the first element set (determined at block 102) and the second element set (determined at block 104) may be combined to create a combined element set in which each element identifies a combination of colorants and additional print agent, and a probability that the combination of colorant and additional print agent identified by that element is to be applied to the associated print addressable location. Combining the element sets may, for example, comprise adding together the content of the first element set (e.g. defining NPs for CMYK colorants) and the second element set (e.g. defining NPs for a fixer, F) to create the combined element set defining NPs for CMYKF. The combined element set may be used by a print apparatus to print each print addressable location according to the determined associated elements.

FIG. 2 shows an illustration of various half-tone representations of a region of a two-dimensional image to be printed. The half-tone representations are 4×4 matrices, each cell of a matrix representing a print addressable location. FIG. 2A illustrates an example of a half-tone matrix 202 of the region of the image having been converted into greyscale. An additional matrix 204 is shown which corresponds to the matrix 202, and which includes values 0 to 5, representing six half-tone levels of the region, for clarity. For ease of discussion, the rows and columns of the matrices are numbered 1, 2, 3, 4 and a, b, c, d respectively. In the example shown in FIG. 2A, cells 2b and 4d of the matrix 202 correspond to the darkest parts of the image, having half-tone values of 5, and cells 1d, 2a and 4c correspond to the lightest parts of the image, having half-tone values of 0. The cells having half-tone values of 0 may be considered to correspond to print addressable location onto which no colorant is to be delivered during the printing operation.

FIG. 2B is an illustration of a color half-tone matrix 206 for the region shown in the matrix 202. Corresponding labeling is used for the rows and columns of the matrix 206 as for the matrices 202 and 204. For the region represented by the matrix 206, cyan and magenta colorants are to be used. In this example, a first element set (e.g. an NPac) may be determined that includes the elements (NPs): CM (a combination of cyan and magenta), M, C and blank/white (W). An additional matrix 208 is shown which corresponds to the matrix 206, and which includes an indicator (CM, M, C, W) of the element (NP) in each cell of the matrix, for clarity. In the example shown in FIG. 2B, for example, cells 2b and 4d of the matrix 208 correspond to blank (W) elements (NPs), the cells 1d, 2a and 4c correspond to a CM element (NP), and the cells 1b, 3d and 4a correspond to a C element (NP). In this example, the elements, or NPs, are determined in the order: CM, M, C, W (blank). It will be apparent from the above discussion that, if the NP order were changed, for example to W, C, M, CM, then a different arrangement would result.

The amount of additional print agent to be applied within a given region may be determined based on a number of factors. For example, it may be intended that, at a particular print addressable location, a small amount of additional print agent (e.g. 15% of the total amount of colorant at that print addressable location) is sufficient. The decision may be take into account the benefit versus the cost of applying the additional print agent. An appropriate amount of additional print agent to be delivered may, for example, be determined by experimentation. In this example, it is assumed that an additional print agent is to be applied to 5 of the 16 cells in the matrix. As with the determination of the first element set, the order in which the elements (NPs) are processed in the second element set has an effect on which print addressable locations at which the additional print agent is to be delivered. FIG. 2C is an illustration of a matrix 210 in which the cells 1d, 2a, 2c, 3b and 4c are indicated as being print addressable locations in which additional print agent is to be delivered. In this example, it is intended that the additional print agent is to be delivered at locations where colorant is delivered (i.e. to coincide with the colorant). Therefore, the elements, or NPs, are determined in the order: Fixer (F), Blank (W). As a result, the additional print agent is to be delivered a print addressable locations where the darkest colorant NPs (i.e. CM and M) are also to be delivered. An overlay matrix 212 in FIG. 2C shows the positions of the additional print agent (from the matrix 210) overlaying positions where colorant is to be delivered (from the matrix 206).

If, however, the intention is that the additional print agent is to be delivered at print addressable locations where no colorant has been delivered (e.g. to protect the printable substrate that contains no colorant), then the elements, or NPs, may be determined in the reverse order: Blank (W), Fixer (F). FIG. 2D is an illustration of a matrix 212 which indicates the print addressable locations at which the addition print agent is to be delivered in such an example. In this example, the cells 1a, 2b, 2d, 4b and 4d are indicated as being print addressable locations in which additional print agent is to be delivered. Each of these cells corresponds with a cell in the matrix 208 at which no colorant is to be delivered. An overlay matrix 216 in FIG. 2D shows the positions of the additional print agent (from the matrix 214) overlaying positions where no colorant is to be delivered (from the matrix 206).

Referring again to FIG. 2C, it will be noted that, while some of the cells in which colorant is to be delivered are also to be provided with additional print agent, some cells (i.e. 1b, 3d and 4a) are to have colorant but no additional print agent delivered. Similarly, in FIG. 2D, cells 1c, 3a and 3c are to remain blank, with no colorant and no additional print agent. The degree to which overprinting or not overprinting (i.e. applying additional print agent to blank cells) results depends on the NPac at each print addressable locations. For example, if, for colorant, a print addressable location has an NPac: [W: 75%, C: 25%, and for additional print agent (e.g. fixer), the print addressable location has an NPac: [W: 50%, Fixer (F): 50%], then it is clear that just 25% of the ‘Fixer locations’ will coincide with ‘C locations’; once fixer has been allocated to all of the cyan locations, there will be no remaining cyan locations to which fixer can be delivered. In some examples, however, the relative amounts of colorant and additional print agent may be taken into account by determining the additional fluid NPac as a function of the colorant NPac. Put another way, in some examples, determining the second element set (at block 104) may comprise determining the second element set as a function of the first element set. In some examples, look-up tables (LUTs) may be used to map NPacs to a particular color space (e.g. RGBs/CMYKs) and to map NPacs to the additional print agent/fixer.

According to one example, the second element set may be determining as a function of the first element set using the following technique. A region (e.g. the region represented by the matrix 202 in FIG. 2A) is analyzed to determine the number of blank cells (i.e. to determine how much of the printable substrate is to receive no colorant). If it is intended that overprinting of colorant with additional print agent to be prioritized (i.e, an overprinting priority), then the second element set may be determined such that the elements (NPs) of the additional print agent result in a corresponding amount of additional print agent (e.g. fixer), to cover all of the locations where colorant is to be delivered. The NPs for the additional print agent may be determined to define a number of drops to be applied at each print addressable location. For example, if the colorant NPac is [C: 20%, W: 80%], and the intention is to deliver 40% additional print agent (e.g. fixer) such that it overprints the colorant, then the second element set may be determined such that two drops of fixer are to be delivered over the colorant locations. Thus, the NPac might be: [FF: 20%, W: 80%], where FF represents two drops of fixer. This may be referred to as a two-drop state of fixer. On the other hand, if the amount of fixer to be delivered is lower than the number of locations containing colorant (e.g. if the intention is to deliver 10% additional print agent at colorant locations), then a single-drop state of fixer can be used. In such cases, not all of the colorant locations may be overprinted with fixer, as is the case in the example shown in FIG. 2C. Thus, determining the second element set may, in some examples, comprise determining, for each element, an amount of print agent or print agent combination to be applied to the associated print addressable location based on the first element set associated with the print addressable location.

The examples shown in FIGS. 2C and 2D represent extremes, where the additional print agent is intended to be overprinted (FIG. 2C) or intended to be printed entirely at blank locations (FIG. 2D). In some examples, however, an intermediate approach may be taken, where a combination of delivering additional print agent at colorant locations and blank locations may be intended. To achieve this, elements in the second element set (i.e. fixer NPs) may be determined such that print addressable locations which are blank (i.e. with no colorant) are provided with blank locations at adjacent locations, resulting in a more gradual combination of overprinting or non-overprinting. For example, to combine (i.e. overprint) the colorant and the additional print agent (referred to in this example as fixer, F), the fixer NPs are at the same ‘end’ of the NP-order (e.g. starting with the lower tones/values) as the colorant NPs in the element set, and to avoid overprinting (i.e. to print the fixer in blank locations), the fixer NPs are at the ‘opposite end’ (starting with the higher tones/values) in the element set. Intermediate results can be achieved by using an NP order in which the fixer NPs are sandwiched between two blank NPs, for example. Thus, if a light-to-dark order is used for the color NPs then, for overprinting, the order used for the fixer NPs might be [w, F, FF, FFF] (for a case where we have 3 fixer NPs, with F, FF and FFF corresponding to 1, 2 and 3 drops of fixer respectively), while if the opposite effect (i.e. not overprinting) is intended, the order for the fixer NPs might be [FFF, FF, F, w] (or [F, FF, FFF, w]). For intermediate cases, w may be divided into two—w1, w2—such that the NP order might be [w1, F, FF, FFF, w2] with the sum of w1 and w2 equal to w. The offsets (i.e. the split between w1 and w2) may depend on the proportional amount of fixer and the intended offset. For example, if the proportion of fixer is 15% and it is intended that 5% of the fixer does not coincide with colorant, then the following NPac may be used [w1: 5%, F: 15%, w2: 80%].

The techniques described herein may be used to achieve overprinting, or to achieve the separate (non-overprinting) of print agent and colorant. In some cases, misalignment of print agent delivery mechanisms (e.g. print heads and/or nozzles) may result in a misalignment of the delivery of the colorant and/or the additional print agent at a particular print addressable location. Such misalignment and dot-placement errors may be addressed or mitigated by using a filter. In some examples, determining the second element set may comprise applying a convolution filter. For example, a Gaussian filter may be applied to achieve Gaussian blurring. In other examples, adjustments may be made at the half-toning stage to favor a green-to-blue noise half-toning matrix rather than a blue-noise matrix, such that, where overprinting of a colorant and additional print agent is intended, clustering (e.g. using green tones) is enhanced. For locations where no additional print agent is intended to be delivered, blue noise may be favored, resulting in less clustering. The filter may be applied to the half-tone matrix (e.g. a half-tone matrix defining colorant amounts, or the half-tone matrix defining the combination of colorant and additional print agent).

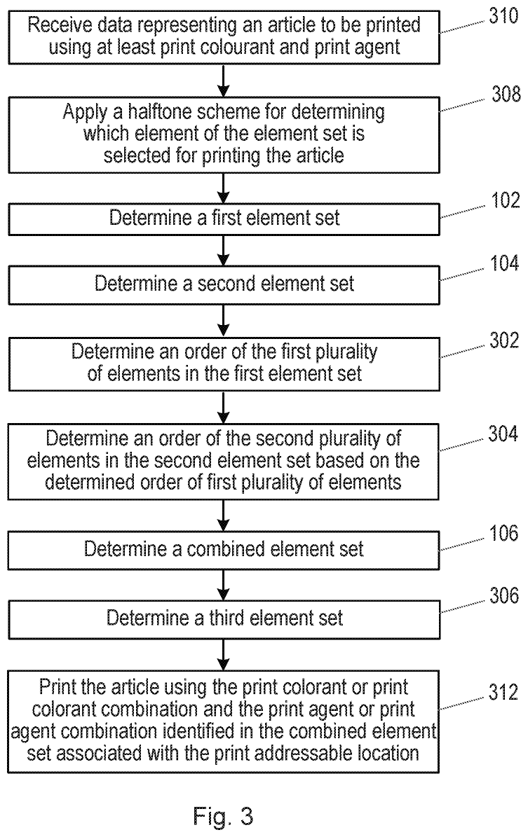

FIG. 3 is a flowchart of a further example of a method 300. The method 300 may be a computer implemented method of determining or generating an element set, which may be carried out by a processor or multiple processors. The method 300 may comprises a block or blocks from the method 100 discussed above. As described above with reference to FIG. 2, the method 300 may comprise, at block 302, prior to determining the combined element set (at block 106), determining an order of the first plurality of elements in the first element set. The order of the first plurality of blocks may be determined when determining the first element set, or after block 102 and prior to block 104. At block 304, the method 300 may comprise determining an order of the second plurality of elements in the second element set based on the determined order of first plurality of elements. Thus, the order of the elements (NPs) for the additional print agent may be determined (e.g. F then W, or W then F) based on whether it is intended that the additional print agent coincides with the locations of the colorant (sometimes referred to as overprinting priority), or that the additional print agent is delivered to blank print addressable locations (sometimes referred to a blank priority). In other words, the order of the second plurality of elements may, in some examples, be determined based on an intended degree of overprinting of the print agent on the colorant.

In some examples, it may be intended that multiple additional print agents are to be delivered over colorant during a printing operation. For example, a printing operation may involve a fixer and a gloss enhancer being delivered over a colorant. Thus, a further element set may be determined, and the combined element set may be determined based on all of the determined element sets. Therefore, in some examples, the method 300 may comprises, at block 306, determining, by processing circuitry, a third element set to be associated with the print addressable location, the third element set comprising a third plurality of elements, wherein each element of the third plurality of elements identifies an additional print agent or additional print agent combination and is associated with a probability that the additional print agent or additional print agent combination identified by that element is to be applied to the associated print addressable location. Determining the combined element set may be based on the first element set, the second element set and the third element set. In other examples, yet further elements sets may be determined and used to determine the combined element set.

As discussed above, prior to determining the first element set at block 102, an article to be printed may undergo a half-toning operation. Thus, the method 300 may comprise, at block 308, applying a half-tone scheme for determining which element of the element set is selected for printing the article, wherein the half-tone scheme comprises a parallel random weighted area coverage selection, PARAWACS, scheme.

At block 310, the method 300 may comprise receiving data representing an article to be printed using at least print colorant and print agent. The data may, for example, comprise two-dimensional data, such as text, an image to be printed on a printable substrate, or an object, a model or the like, to be generated using additive manufacturing. The data may specify, for each of a plurality of print addressable locations, an intended color. The color may be expressed in any color space, and may in some examples be a color space which is independent of any print apparatus (a “device independent color space”). For example, the device independent color space may be sRGB, Adobe RGB, or may be some other color space, for example a color space which uses an International Commission on Illumination (CIE) color model. Other color space models include Hue-Saturation-Value (HSV), Hue-Saturation-Lightness (HSL), Yule-Nielsen-corrected XYZ, XYZ, LAB or the like. Once the data has been received at block 308, the processing described in the method 100 may be performed to determine the combined element set.

The method 300 may comprise. at block 312, printing the article using the print colorant or print colorant combination and the print agent or print agent combination identified in the combined element set associated with the print addressable location. The whole article may be printed by printing each print addressable location in turn.

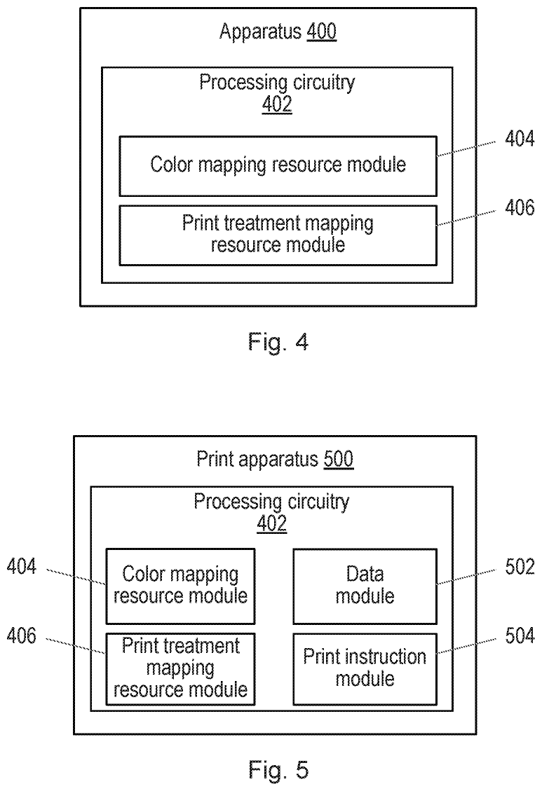

The present disclosure also provides an apparatus. FIG. 4 is a schematic illustration of an example of an apparatus 400. The apparatus 400 may comprise an apparatus for determining or generating an element set, or an apparatus for generating a mapping resource. The apparatus may, for example, perform the methods 100, 300. The apparatus 400 comprises processing circuitry 402. The processing circuitry 402 comprises a color mapping resource module 404 and a print treatment mapping resource module 406.

The color mapping resource module 404 is to generate a color mapping resource comprising a first plurality of element sets to be associated with a print addressable location for printing an article, each element set of the first plurality of element sets comprising a plurality of elements identifying a print colorant or print colorant combination associated with a probability that the print colorant or print colorant combination identified by that element is to be applied to an associated print addressable location. The color mapping resource module 404 may generate the color mapping resource using the techniques discussed herein. The elements may comprise NPs, and the element sets may comprise NPacs or MVocs, as discussed above. As described previously, the print colorant may comprise print agent intended to apply color to the article to be printed.

The print treatment mapping resource module 406 is to generate a print treatment mapping resource comprising a second plurality of element sets to be associated with the print addressable location for printing the article, each element set of the second plurality of element sets comprising a plurality of elements identifying a print treatment associated with a probability that the print treatment identified by that element is to be applied to the associated print addressable location. The print treatment may be considered to comprise print fluid that is not colorant, and which is to provide some other effect in relation to the article to be printed.

The processing circuitry 402 is to generate, based on the color mapping resource and the print treatment mapping resource, a combined mapping resource defining a probability that the identified print colorant or print colorant combination and the identified print treatment are to be applied to the associated print addressable location. The combined mapping resource may comprise a combination of the color mapping resource and the print treatment mapping resource, which can be used to control the delivery of both the print colorant and the print treatment on to each print addressable locations of the article to be printed.

FIG. 5 is a schematic illustration of a further example of an apparatus 500, such as an apparatus for determining or generating an element set, or an apparatus for generating a mapping resource. The apparatus 500 may comprise features of the apparatus 400 discussed above. The apparatus 500 may comprise a data module 502 to acquire data representing an article to be printed. As discussed with reference to the methods 100, 300, the data may comprise data representing a two-dimensional image, or data representing a three-dimensional object to be generated. The apparatus 500 may comprise a print instruction module 504 to determine print instructions based on the acquired data, and using the combined mapping resource.

In some examples, the apparatus 500 may comprise print apparatus. Such print apparatus may print an article according to the determined print instructions. In other words, the print apparatus may deliver printing fluids (e.g. print colorant and print treatment) in accordance with the print instructions, in order to form or generate the article.

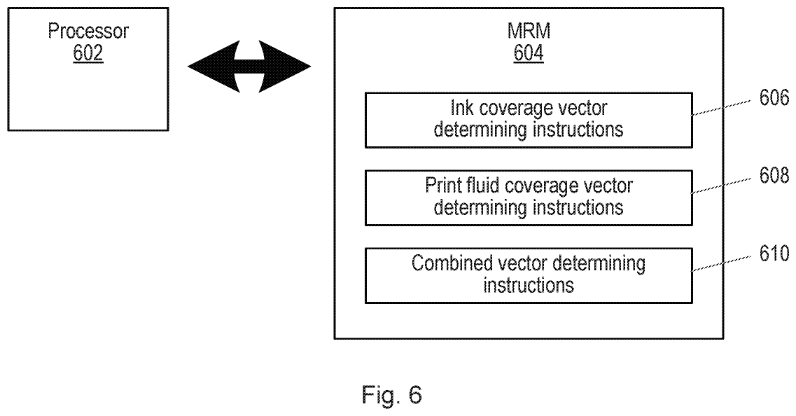

The present disclosure also provides a machine-readable medium. FIG. 6 is a schematic illustration of a machine-readable medium 604 in communication with a processor 602. The machine-readable medium 604 comprises instructions which, when executed by a processor 602, cause the processor to perform functions, such as those described herein. In some examples, instructions may cause the processor 602 to perform blocks of the method 100, 300 described above. The machine-readable medium 604 may comprise instructions (e.g. ink coverage vector determining instructions 606) which, when executed by a processor 602, cause the processor to determine an ink coverage vector defining, for a print addressable location, a value representing a probability that a particular ink or a particular combination of ink is to be applied to the print addressable location. The machine-readable medium 604 may comprise instructions (e.g. print fluid coverage vector determining instructions 608) which, when executed by a processor 602, cause the processor to determine a print fluid coverage vector defining, for the print addressable location, a value representing a probability that a particular print fluid or a particular combination of print fluid is to be applied to the print addressable location. The machine-readable medium 604 may comprise instructions (e.g. combined vector determining instructions 610) which, when executed by a processor 602, cause the processor to generate, from a combination of the ink coverage vector and the print fluid coverage vector, a combined vector. The combined vector may, for example, comprise a combined vector defining, for the print addressable location, values representing probabilities that ink or ink combinations and print fluid or print fluid combinations are to be applied to the print addressable location.

In some examples, the machine-readable medium 604 may comprise instructions which, when executed by a processor 602, cause the processor to acquire data representing an article to be printed using at least ink and print fluid. Further instructions may cause the processor 602 to generate print instruction data to be used to print the article using the ink or ink combination and the print fluid or print fluid combination identified in the combined vector associated with the print addressable location. The print instruction data may be used by a print apparatus to print the article.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfill the functions of several units recited in the claims.

The features of any dependent claim may be combined with the features of any of the independent claims or other dependent claims.

1. A method comprising:
determining, by processing circuitry, a first element set to be associated with a print addressable location, the first element set comprising a first plurality of elements, wherein each element of the first plurality of elements identifies a print colorant or print colorant combination and is associated with a probability that the print colorant or print colorant combination identified by that element is to be applied to the associated print addressable location;
determining, by processing circuitry, a second element set to be associated with the print addressable location, the second element set comprising a second plurality of elements, wherein each element of the second plurality of elements identifies a print agent or print agent combination and is associated with a probability that the print agent or print agent combination identified by that element is to be applied to the associated print addressable location; and
determining, by processing circuitry, a combined element set based on the first element set and the second element set.

2. A method according to claim 1, further comprising:
receiving data representing an article to be printed using at least print colorant and print agent; and
printing the article using the print colorant or print colorant combination and the print agent or print agent combination identified in the combined element set associated with the print addressable location.

3. A method according to claim 1, further comprising:
determining an order of the first plurality of elements in the first element set; and
determining an order of the second plurality of elements in the second element set based on the determined order of first plurality of elements.

4. A method according to claim 3, wherein the order of the second plurality of elements is determined based on an intended degree of overprinting of the print agent on the colorant.

5. A method according to claim 1, wherein determining the second element set comprises determining the second element set as a function of the first element set.

6. A method according to claim 5, wherein determining the second element set comprises determining, for each element, an amount of print agent or print agent combination to be applied to the associated print addressable location based on the first element set associated with the print addressable location.

7. A method according to claim 1, wherein determining the second element set comprises applying a convolution filter.

8. A method according to claim 1, further comprising applying a half-tone scheme for determining which element of the element set is selected for printing the article, wherein the half-tone scheme comprises a parallel random weighted area coverage selection, PARAWACS, scheme.

9. A method according to claim 1, wherein the elements are Neugebauer Primaries, NPs.

10. A method according to claim 1, further comprising:
determining, by processing circuitry, a third element set to be associated with the print addressable location, the third element set comprising a third plurality of elements, wherein each element of the third plurality of elements identifies an additional print agent or additional print agent combination and is associated with a probability that the additional print agent or additional print agent combination identified by that element is to be applied to the associated print addressable location;
wherein determining the combined element set is based on the first element set, the second element set and the third element set.

11. An apparatus, comprising:
processing circuitry comprising:
a color mapping resource module to generate a color mapping resource comprising a first plurality of element sets to be associated with a print addressable location for printing an article, each element set of the first plurality of element sets comprising a plurality of elements identifying a print colorant or print colorant combination associated with a probability that the print colorant or print colorant combination identified by that element is to be applied to an associated print addressable location; and
a print treatment mapping resource module to generate a print treatment mapping resource comprising a second plurality of element sets to be associated with the print addressable location for printing the article, each element set of the second plurality of element sets comprising a plurality of elements identifying a print treatment associated with a probability that the print treatment identified by that element is to be applied to the associated print addressable location;
wherein the processing circuitry is generate, based on the color mapping resource and the print treatment mapping resource, a combined mapping resource defining a probability that the identified print colorant or print colorant combination and the identified print treatment are to be applied to the associated print addressable location.

12. An apparatus according to claim 11, wherein the processing circuitry further comprises:
a data module to acquire data representing an article to be printed; and
a print instruction module to determine print instructions based on the acquired data, and using the combined mapping resource.

13. An apparatus according to claim 12, comprising:
print apparatus to print an article according to the determined print instructions.

14. A machine-readable medium comprising instructions which, when executed by a processor, cause the processor to:
determine an ink coverage vector defining, for a print addressable location, a value representing a probability that a particular ink or a particular combination of ink is to be applied to the print addressable location;
determine a print fluid coverage vector defining, for the print addressable location, a value representing a probability that a particular print fluid or a particular combination of print fluid is to be applied to the print addressable location; and
generate, from a combination of the ink coverage vector and the print fluid coverage vector, a combined vector.

15. A machine-readable medium according to claim 14, further comprising instructions which, when executed by a processor, cause the processor to:
acquire data representing an article to be printed using at least ink and print fluid; and
generate print instruction data to be used to print the article using the ink or ink combination and the print fluid or print fluid combination identified in the combined vector associated with the print addressable location.
